(19) United States
(12) Patent Application Publication
(10) Pub. No.: US 2015/0257607 A1
(43) Pub. Date: Sep. 17, 2015

(54) SPOON CONFIGURED TO REMOVE FLOATING OIL

(71) Applicant: PHILLIP JOSEPH GRILLO, KOUNTZE, TX (US)

(72) Inventor: PHILLIP JOSEPH GRILLO, KOUNTZE, TX (US)

(21) Appl. No.: 14/211,728

(22) Filed: Mar. 14, 2014

(51) Int. Cl. A47J 43/28; A47G 21/04

(52) U.S. Cl. CPC A47J 43/284; A47G 21/04

(57) ABSTRACT

A spoon is configured to remove oil from a food upper surface on a food. The spoon has a lower portion, configured to receive the oil from below the lower portion through the lower portion such that the oil can be stored in the lower portion. An upper portion is mechanically coupled to the lower portion and is configured to be held by a human hand. The lower portion is configured to be partially submerged into the food such that the oil on the food upper surface enters the lower portion and is removed from the food.

### BACKGROUND

The embodiments herein relate generally to kitchen utensils.

Certain recipes that contain meat with longer cooking times such as chili, gumbo, and spaghetti sauce have the fat within the meat to render out as oil and accumulate on a food product surface in a pot. Prior to embodiments of the disclosed invention, a user would either have to skim the oil off with a spoon or ladle or pour the food product into another container where the oil was captured as one poured the contents back into the original cooking vessel.

The prior art ladle was ineffective in this regard because it was extremely inefficient. The pouring solution caused a food temperature change that had a poor effect on food taste. Embodiments of the disclosed invention solve these problems.

### SUMMARY

A spoon is configured to remove oil from a food upper surface on a food. The spoon has a lower portion, configured to receive the oil from below the lower portion through the lower portion such that the oil can be stored in the lower portion. An upper portion is mechanically coupled to the lower portion and is configured to be held by a human hand. The lower portion is configured to be partially submerged into the food such that the oil on the food upper surface enters the lower portion and is removed from the food.

In some embodiments the lower portion can further comprise a tube cylinder that is mechanically coupled to a hollow spherical cap. The hollow spherical cap is perforated with an oil port that is configured to permit entry of oil into the lower portion.

In some embodiments, the tube cylinder has a tube cylinder inner radius displaced a tube cylinder thickness from a tube cylinder outer radius. The hollow spherical cap has a hollow spherical cap inner radius displaced a hollow spherical cap thickness from a hollow spherical cap outer radius. The tube cylinder inner radius and the tube cylinder outer radius are less than the hollow spherical cap inner radius or the hollow spherical cap outer radius. In some embodiments, the tube cylinder thickness is approximately equal to the hollow spherical cap thickness.

### BRIEF DESCRIPTION OF THE FIGURES

The detailed description of some embodiments of the invention is made below with reference to the accompanying figures, wherein like numerals represent corresponding parts of the figures.

FIG. 1 is a front perspective view of the invention.

FIG. 2 is a rear perspective view of the invention.

FIG. 3 is a top view of the invention.

FIG. 4 is a side view of the invention.

FIG. 5 is a section view of the invention along line 5-5 in FIG. 3 shown in pre-application.

FIG. 6 is a section view of the invention shown in application.

FIG. 7 is a section view of the invention shown in post application.

### DETAILED DESCRIPTION OF CERTAIN EMBODIMENTS

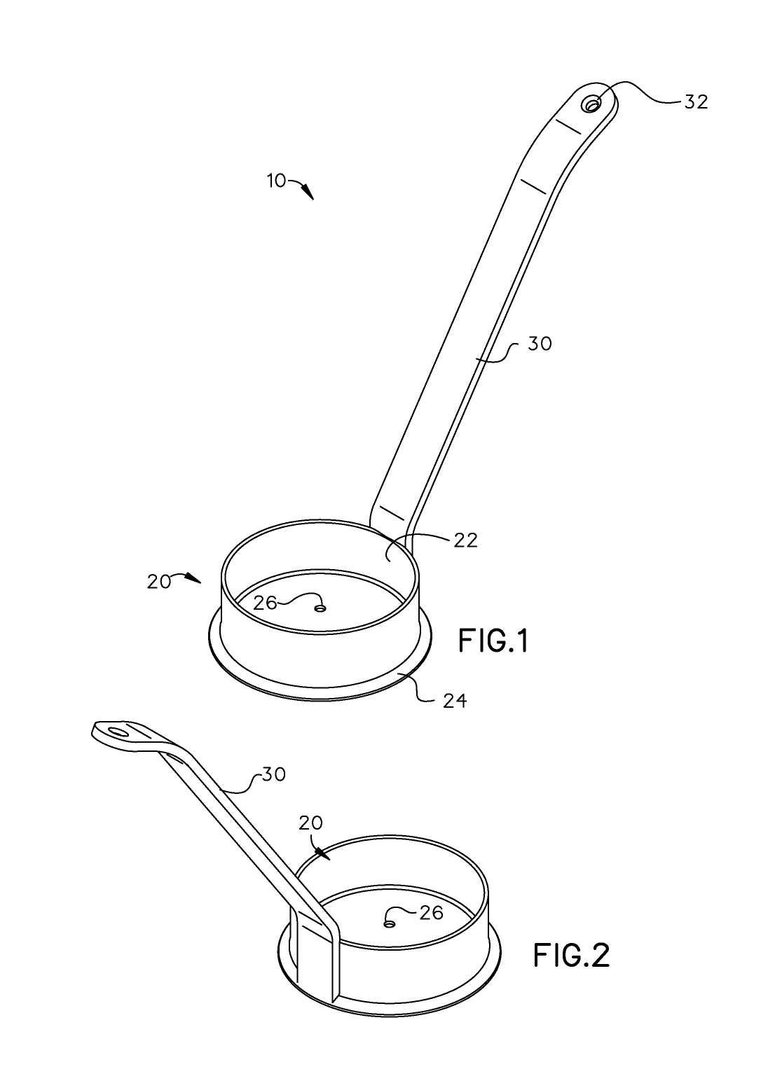

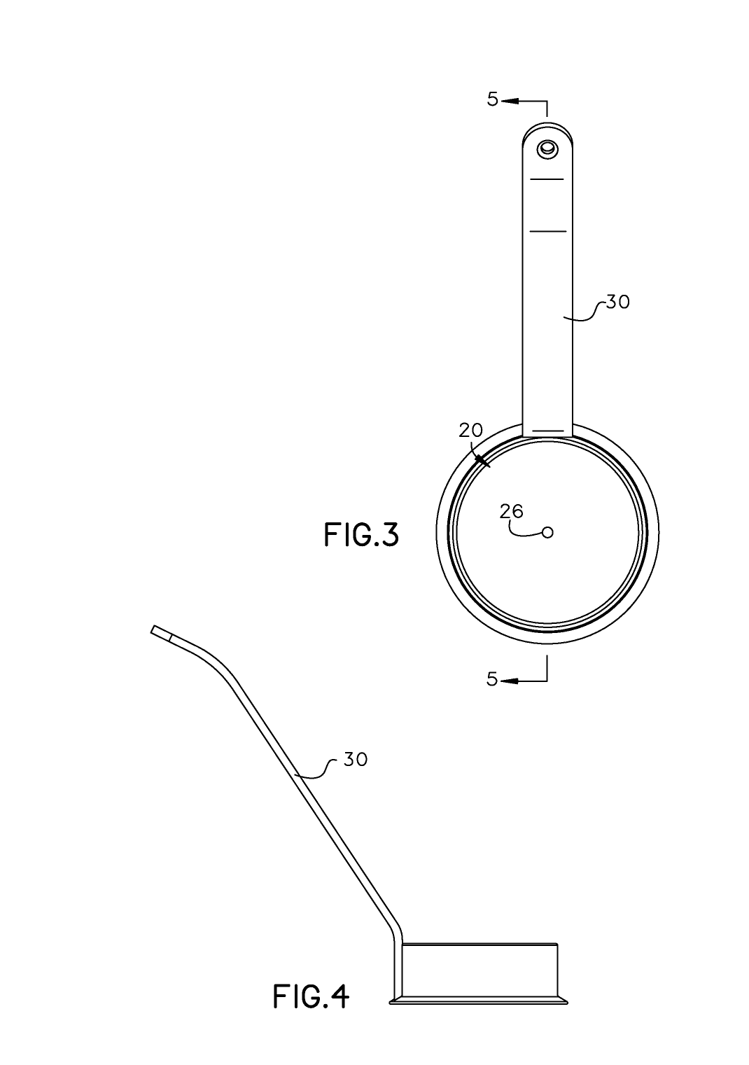

By way of example, and referring to FIG. 1, FIG. 2, FIG. 3 and FIG. 4 one embodiment of the spoon 10 comprises lower portion 20 mechanically coupled to upper portion 30. Lower portion 20 comprises tube cylinder 22 mechanically coupled to hollow spherical cap 24. Hollow spherical cap 24 is perforated with oil port 26.

Tube cylinder 22 is a tube or pipe with a tube cylinder inner radius displaced a tube cylinder thickness from a tube cylinder outer radius. Tube cylinder 22 has a tube cylinder height.

Hollow spherical cap 24 is defined by two concentric spheres. Both concentric spheres are cut by the same axial plane wherein the inner sphere hollows out the outer sphere. Thus, hollow spherical cap 24 has a hollow spherical cap inner radius displaced a hollow spherical cap thickness from a hollow spherical cap outer radius. Hollow spherical cap 24 extends outward from tube cylinder 22. The hollow spherical cap inner radius and the hollow spherical cap outer radius are configured to be greater than the tube cylinder inner radius and the tube cylinder outer radius.

While the hollow spherical cap thickness does not necessary have to equal the tube cylinder thickness, doing so may facilitate some kinds of manufacturing. For instance the present invention can be made with known kitchen grade materials such as aluminum, plastic or wood using conventional material working techniques.

Oil port 26 is a hole extending from the apex of hollow spherical cap 24. Oil port 26 has a length equal to that of hollow spherical cap thickness in order to permit entry of oil O from food F onto an upper surface of hollow spherical cap 24.

Upper portion 30 is mechanically coupled to tube cylinder 22 and hollow spherical cap 24. Upper portion 30 is configured to be held by a human hand. Upper portion 30 is parallel to a portion of tube cylinder 22, but upper portion 30 extends distant from tube cylinder 22 in order to allow a user to hold spoon 10 away from food F as shown below.

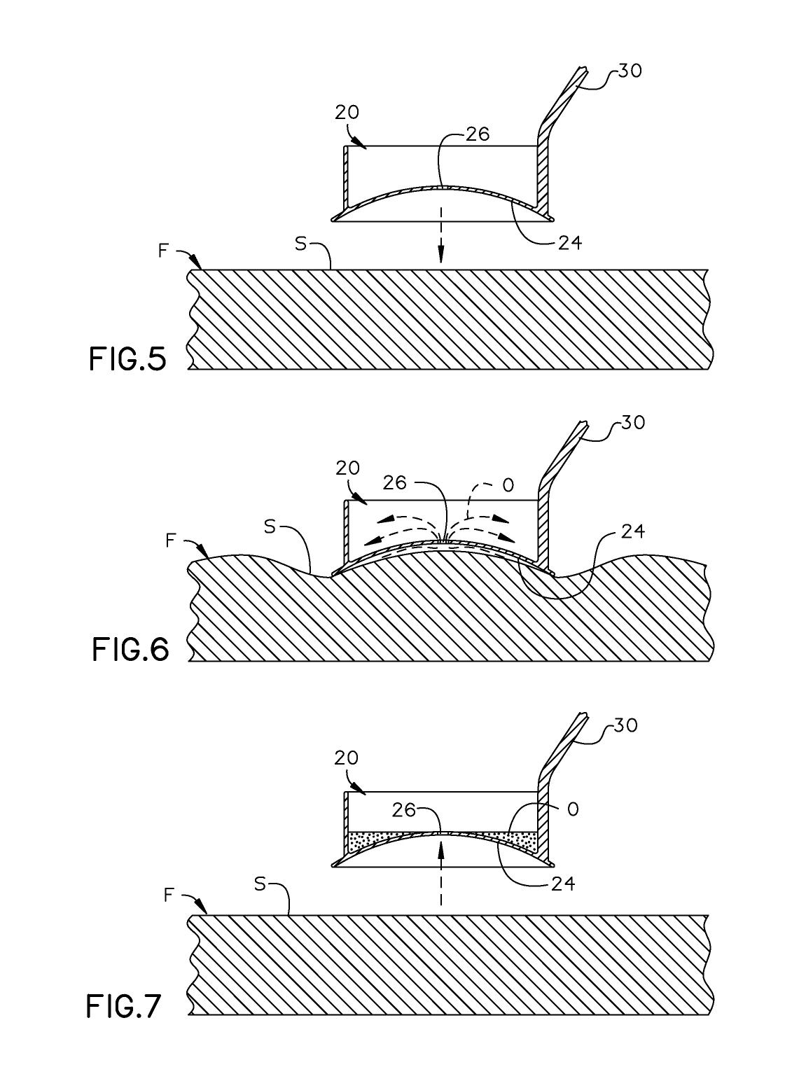

Turning to FIG. 4, FIG. 5 and FIG. 6, food F has food upper surface S which comprises, in part oil O. The user desires to use spoon 10 to remove oil O from food upper surface S. To do this, the user pushes lower portion 20 partially into food F, such that oil O is able to move through oil port 26 and into lower portion 20 onto an upper surface of hollow spherical cap 24.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A spoon, configured to remove an oil from a food upper surface on a food; the spoon comprising:
a lower portion, configured to receive the oil from below the lower portion through the lower portion such that the oil can be stored in the lower portion;
an upper portion, mechanically coupled to the lower portion and configured to be held by a human hand;
wherein the lower portion is configured to be partially submerged into the food such that the oil on the food upper surface enters the lower portion and is removed from the food.

2. The spoon of claim 1, wherein the lower portion further comprises a tube cylinder mechanically coupled to a hollow spherical cap wherein the hollow spherical cap is perforated with an oil port that is configured to permit entry of oil into the lower portion.

3. The spoon of claim 2,
wherein the tube cylinder has a tube cylinder inner radius displaced a tube cylinder thickness from a tube cylinder outer radius;
wherein the hollow spherical cap has a hollow spherical cap inner radius displaced a hollow spherical cap thickness from a hollow spherical cap outer radius;
wherein the tube cylinder inner radius and the tube cylinder outer radius are less than the hollow spherical cap inner radius or the hollow spherical cap outer radius.

4. The spoon of claim 3, wherein the tube cylinder thickness is approximately equal to the hollow spherical cap thickness.
